(19) United States
(12) Patent Application Publication
(10) Pub. No.: US 2026/0336911 A1
(43) Pub. Date: Oct. 29, 2026

(54) BEVERAGE HOLDER WITH INTERIOR SURFACE GEOMETRY FOR ENHANCED INSULATION

(71) Applicant: Cooler Holdings, LLC, Chattanooga, TN (US)

(72) Inventors: Christian Siler, Chattanooga, TN (US); Brent Burchfield, Columbus, OH (US); Robert Green, Columbus, OH (US)

(73) Assignee: Cooler Holdings, LLC, Chattanooga, TN (US)

(21) Appl. No.: 19/656,492

(22) Filed: Apr. 23, 2026

Related U.S. Application Data
(60) Provisional application No. 63/794,051, filed on Apr. 24, 2025.

(51) Int. Cl. B65D 81/38; B29C 44/02; B29K 23/00; B65D 81/26

(52) U.S. Cl. CPC B65D 81/3879; B29C 44/02; B65D 81/261; B65D 81/3881; B29K 2023/083

(57) ABSTRACT

A beverage holder and a method of manufacturing the same. The beverage holder comprises a resilient foam body defining an interior bore configured to receive a beverage container. An interior surface of the body bounding the interior bore includes a plurality of surface features defining discrete contact zones and intervening void spaces, wherein the contact zones engage the exterior surface of the beverage container, and the void spaces retain an air layer providing thermal insulation. In preferred embodiments, the body has a corrugated wall profile in which interior facing crests and exterior facing crests are radially offset, simultaneously defining the interior contact zones and void spaces and a textured exterior gripping surface. The method of manufacturing comprises introducing a foam material into a mold cavity having a corrugated interior profile and expanding the foam material to form the body and its surface features.

### CROSS-REFERENCE TO RELATED APPLICATION

This non-provisional utility patent application claims the benefit of priority under 35 U.S.C. § 119(e) to U.S. Provisional Patent Application No. 63/794,051, filed Apr. 24, 2025, entitled “BEVERAGE HOLDER,” the entire disclosure of which is incorporated herein by reference in its entirety.

### FIELD

The present invention relates generally to insulating beverage holders, and more particularly to a foam beverage holder formed from an expanded foam material and having a corrugated wall structure that simultaneously provides thermal insulation, reduced insertion and removal friction, and enhanced grip on both interior and exterior surfaces.

### BACKGROUND

Insulating beverage holders, commonly referred to as can coolers, are widely used to maintain the temperature of canned or bottled beverages. Such holders are typically cylindrical or frustoconical foam sleeves sized to receive a standard beverage container such as a twelve-ounce aluminum can.

Prior art beverage holders have been constructed from various foam materials, most commonly neoprene and ethylene-vinyl acetate (EVA) foam, or stainless steel. Each material presents distinct limitations in practical use.

Neoprene insulated holders for beverage containers are highly customizable and widely available, but neoprene, particularly in its open-cell form, is a relatively dense material that absorbs water. When saturated, neoprene loses a significant portion of its insulating efficiency and becomes slippery. Even closed-cell neoprene, which resists water absorption more effectively, has a comparatively higher density than EVA foam and provides insufficient buoyancy to float a filled beverage container in water. In aquatic recreational environments such as swimming pools, lakes, and beaches, neoprene holders tend to sink when filled with a beverage container.

EVA foam coolers and rigid polymer floating insulated beverage container holders address the buoyancy deficiency of neoprene but introduce different problems. Rigid polymer designs are bulky and impractical to hold in normal use. Standard smooth-bore EVA foam beverage holders lack sufficient exterior grip texture for secure handling when wet, and their smooth interior bore surfaces create high frictional contact with the exterior of a beverage container, making insertion and removal difficult, particularly when condensation has formed on a cold can.

A further category of prior art beverage holders comprises vacuum-insulated stainless steel holders, sometimes referred to as can coolers or can insulators. While vacuum-insulated stainless steel holders provide excellent thermal insulation, they are substantially heavier than foam-based holders. A representative vacuum-insulated stainless steel holder for a twelve-ounce aluminum can has a weight of approximately 225 to 270 grams. By contrast, a beverage holder according to the present invention has a weight of approximately 63 grams for the regular can embodiment, representing a weight reduction of approximately 70 to 75 percent. The significant weight reduction of the foam-based holder of the present invention over vacuum-insulated stainless steel alternatives, combined with positive buoyancy and enhanced grip, provides a compelling functional advantage in recreational aquatic environments where carrying weight and floatability are material concerns.

Furthermore, prior art foam beverage holders present a substantially flat, continuous interior bore surface that contacts the exterior of a beverage container across the full interior surface area. This configuration provides no mechanism for trapping insulating air between the holder and the can, and the high total contact surface area contributes to both thermal inefficiency and elevated friction.

Accordingly, there exists a need in the art for a beverage holder that provides improved thermal insulation, enhanced grip in wet conditions, reduced insertion and removal friction, and sufficient buoyancy to float a filled beverage container, all within a single integrated and manufacturable structure.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### SUMMARY

The present invention provides a beverage holder comprising a body formed from a resilient foam material. The body defines a central longitudinal axis, an upper opening, and an interior bore configured to receive a beverage container. The foam wall of the body has an undulating or corrugated wall profile defining a plurality of interior facing crests that project radially inward toward the central longitudinal axis and a plurality of exterior facing crests that project radially outward from the central longitudinal axis. The interior facing crests and the exterior facing crests alternate around the circumference of the body in a radially offset arrangement such that each interior facing crest corresponds to an exterior facing valley at a corresponding angular position, and each exterior facing crest corresponds to an interior facing valley at a corresponding angular position.

The interior facing crests define discrete contact zones that contact the exterior surface of a beverage container received in the interior bore. The interior facing valleys between successive interior facing crests define void spaces that trap air between the interior surface of the holder and the exterior surface of the beverage container, providing an additional thermal insulating barrier. The exterior facing crests simultaneously provide enhanced grip surfaces for a user's hand.

In preferred embodiments, the corrugated wall profile follows a continuous helical path about the central longitudinal axis. The body is preferably formed from EVA foam having a density sufficiently low to render the beverage holder at least partially buoyant in water when containing a sealed (i.e., unopened and full) beverage container.

In testing, a beverage holder according to the present invention demonstrated a measured displacement of approximately 167 grams and a buoyant force of approximately 0.37 pounds-force (lbf) when loaded with a sealed beverage container, sufficient to maintain positive flotation. By comparison, a representative neoprene beverage holder demonstrated a displacement of approximately 44 grams and a buoyant force of approximately 0.10 lbf when loaded, resulting in net negative buoyancy and sinking. A representative vacuum-insulated stainless steel beverage holder, while displacing a greater volume of water, has a gross weight that exceeds its generated buoyant force, also resulting in net negative buoyancy.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1A and FIG. 1B are top perspective views of beverage holders according to a first (tall) embodiment and a second (short) embodiment of the present invention, respectively, showing the exterior surface geometry including a textured spiral pattern used on beverage holders of two heights;

FIG. 2 is a front elevation view of the beverage holder of FIG. 1A;

FIG. 3 is a left side elevation view thereof;

FIG. 4 is a right side elevation view thereof;

FIG. 5 is a rear elevation view thereof;

FIG. 6 is a top plan view of the beverage holder of FIG. 1A, showing an open interior, bore and interior facing crests;

FIG. 7 is a bottom plan view of the beverage holder of FIG. 1A;

FIG. 8 is a cross-sectional view of the beverage holder of FIG. 6 taken along line “8-8,” illustrating the interior bore, corrugated wall profile defining discrete contact zones and intervening void spaces, and a foam body wall thickness; and

FIG. 9 shows the beverage holder of FIG. 8 after a beverage container (i.e., a can) has been fully inserted into the beverage holder; and

FIG. 10 is a cross-sectional view of the foam body wall of the beverage holder of FIG. 8, taken along line “10-10”; and

FIG. 11 depicts a beverage container placed against interior facing crests of a portion of the beverage holder of FIG. 10 labeled “FIG. 11,” illustrating void spaces that trap air between an interior surface of the beverage holder and an exterior surface of the beverage container.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific embodiments and applications are provided only as examples. Various modifications to the preferred embodiments will be readily apparent to those skilled in the art, and the general principles defined herein may be applied to other embodiments and applications without departing from the spirit and scope of the invention. The present invention is not intended to be limited to the embodiments shown, but is to be accorded the widest scope consistent with the principles and features disclosed herein.

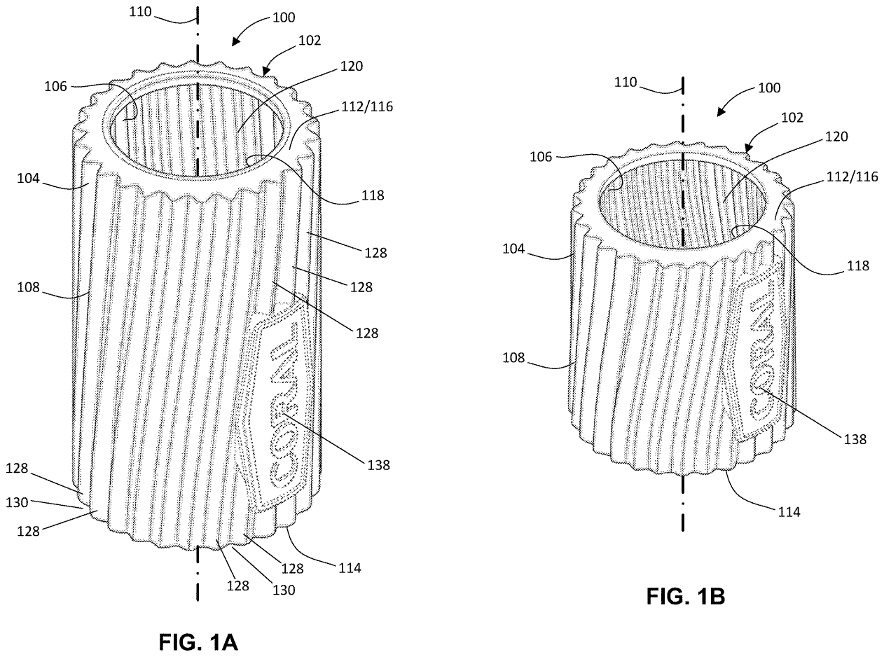

Referring now to the drawings, in which like reference numerals designate like or corresponding parts throughout the several views, FIG. 1A illustrates a tall beverage holder 100 according to a first embodiment of the present invention, and FIG. 1B illustrates a short beverage holder according to a second embodiment of the present invention. As used herein, the term beverage holder refers broadly to an insulating sleeve, jacket, or insulating can cooler configured to receive and retain a beverage container such as a can or bottle.

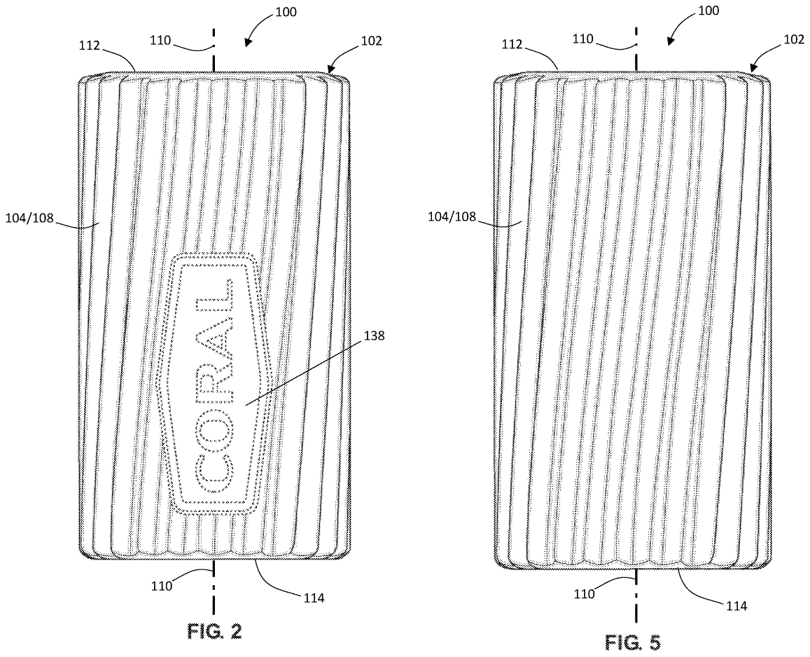

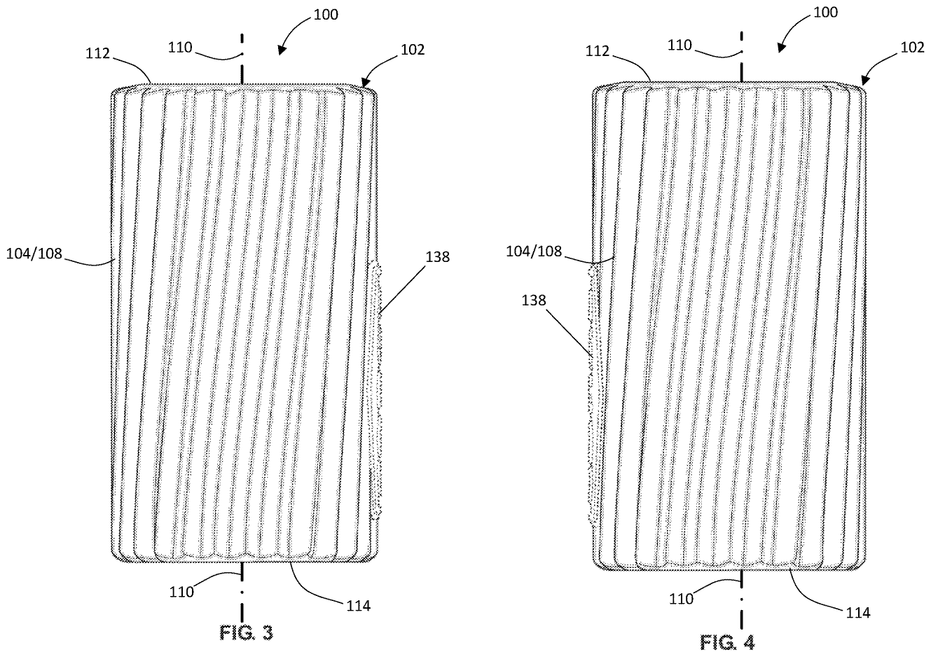

With continued reference to FIGS. 1A and 1B and with further reference to FIGS. 2-5, the beverage holder 100 comprises a body 102 formed from a resilient, compressible foam material. In a preferred embodiment, the body 102 is formed from ethylene-vinyl acetate (EVA) foam, which provides a desirable combination of compressibility, low density, and thermal insulating properties. The EVA foam composition of the body 102 imparts sufficient buoyancy to the beverage holder 100 such that a sealed, full beverage container (e.g., a twelve-ounce aluminum can) received within the beverage holder remains at least partially buoyant when placed in water, including water encountered in recreational settings such as swimming pools, lakes, and oceans. This buoyancy characteristic is a significant functional advantage over prior art beverage holders formed from denser materials such as neoprene, which are prone to sinking when filled.

The body 102 defines an exterior surface 104 and an interior surface 106 that together bound the foam wall 108 of the body. The body 102 further defines a central longitudinal axis 110 extending between an upper end 112 and a lower end 114 of the beverage holder 100. The body 102 is generally cylindrical or frustoconical in shape, sized and configured to receive a standard format beverage container, including but not limited to twelve-ounce aluminum cans. As will be appreciated by those skilled in the art, the dimensions of the body 102 may be varied to accommodate beverage containers of different sizes and formats without departing from the scope of the present invention.

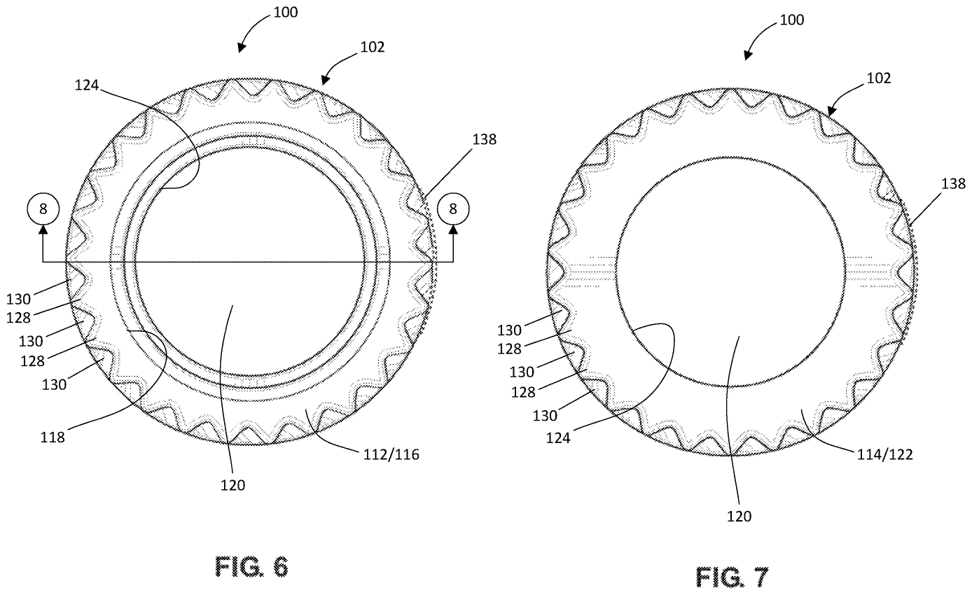

As shown in FIGS. 6-9, an upper retaining lip 116 for securely holding a beverage container inserted into the body 102 is provided at the upper end 112. The lip 116 defines an upper opening 118 that provides access to an interior bore 120 configured to receive a beverage container. The upper opening 118 is dimensioned to permit insertion and removal of a beverage container through the upper end 112 of the beverage holder 100. In a preferred embodiment, the interior bore 120 is sized such that a standard twelve-ounce aluminum beverage can is received therein with a controlled, snug fit with retaining lip 116 that retains the can during normal handling while permitting removal with the reduced frictional force described in greater detail below.

The lower end 114 of the body 102 is bounded by a bottom wall 122. In a preferred embodiment, the bottom wall 122 includes one or more drainage apertures 124 to permit water ingress and egress during use in aquatic environments, thereby permitting rapid drainage of water from the interior bore 120 upon removal from an aquatic environment, restoring the void spaces 136 and their associated insulating air layer following submersion or water exposure. The bottom wall 122 further provides a stable resting surface when the beverage holder 100 is placed on a flat surface.

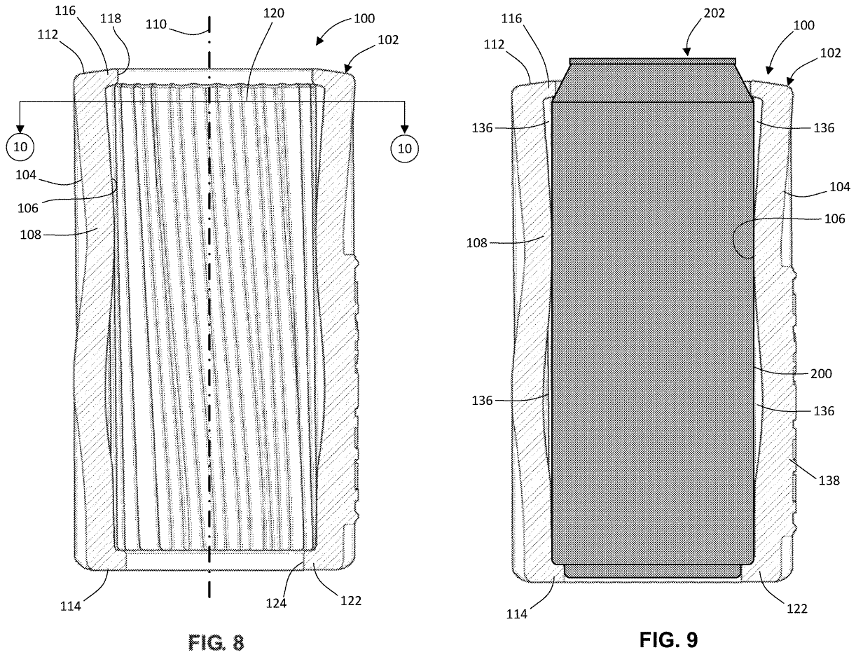

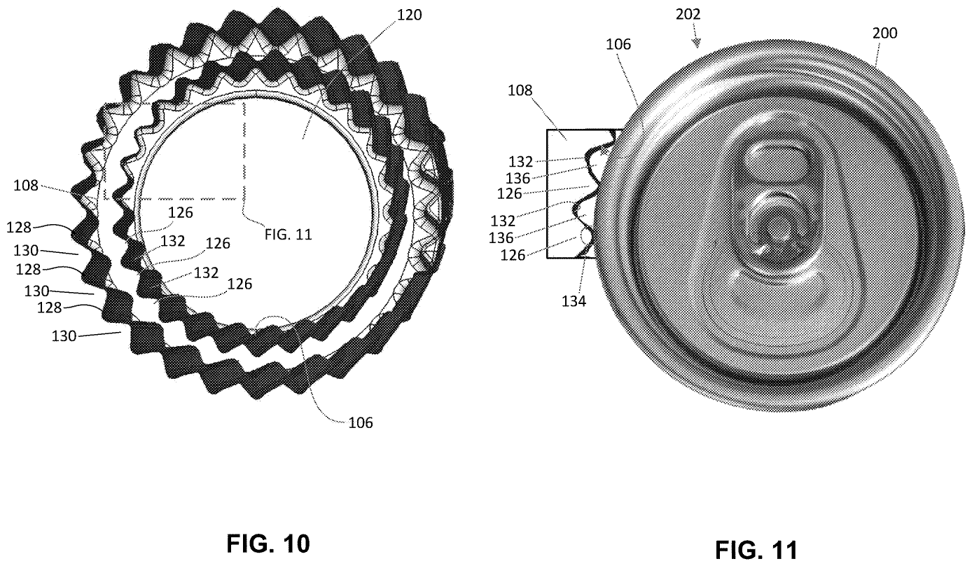

Referring now to FIG. 10, and with reference also to FIGS. 6 and 8, the foam wall 108 of the body 102 incorporates a corrugated wall profile that, when viewed in cross-section taken in a plane perpendicular to the central longitudinal axis 110, is not flat or uniform but rather undulates in a sinusoidal or wave-like pattern in the radial direction relative to the central axis 110.

Specifically, the foam wall 108 defines a plurality of interior facing crests 126, each of which projects radially inward toward the central axis 110, and a plurality of exterior facing crests 128, each of which projects radially outward away from the central axis. As best illustrated in FIG. 10, the interior facing crests 126 and the exterior facing crests 128 are radially offset from one another in an alternating arrangement around the circumference of the body 102, such that: (a) each interior facing crest corresponds to an exterior facing valley 130 at the same angular position about the central axis, meaning that the foam wall 108 is relatively thinner and displaced radially outward at the location of each interior facing crest; and (b) each exterior facing crest corresponds to an interior facing valley 132 at the same angular position about the central axis, meaning that the foam wall is also relatively thinner and displaced radially inward at the location of each exterior facing crest.

The alternating corrugated wall profile described above is best understood by reference to FIG. 10, which shows the foam wall 108 in cross-section as a continuous wave form alternating between radially inward displacement at the interior facing crests 126 and radially outward displacement at the exterior facing crests 128, with each crest on one side of the wall corresponding to a valley on the opposite side at the same angular position. This corrugated profile is maintained continuously around the full circumference of the body 102 and extends along the full axial length of the body 102 in a helical or spiral orientation about the central axis 110, as further described below.

The interior facing crests 126 of the corrugated wall 108 project radially inward from the interior surface 106 of the body 102 into the interior bore 120. With continued reference to FIG. 10 and with further reference to FIG. 11, the radially inward tips or peaks of the interior facing crests 126 define discrete contact zones 134, the points at which the beverage holder 100 contacts the exterior surface 200 of a beverage container 202 received within the interior bore 120.

With reference to FIGS. 9 and 11, between successive interior facing crests 126, the interior surface 106 recedes radially outward away from the central axis (i.e., center of bore 120, which extends into the page in FIG. 10), corresponding to the locations of the exterior facing crests 128, defining a plurality of interior facing valleys 132 between the interior facing crests. The interior facing valleys 132 define void spaces 136 between the interior surface 106 of the body 102 and the exterior surface 200 of a beverage container 202 received within the interior bore 120. The void spaces 136 are the primary sites of air retention and thermal insulation during use, as described in greater detail below.

Referring to FIGS. 1A and 6, the exterior facing crests 128 of the corrugated wall 108 project radially outward from the exterior surface 104 of the body 102. The exterior facing crests 128 define the primary grip contact surfaces between the exterior of the beverage holder 100 and a user's hand. The tactile ridges formed by the exterior facing crests 128 provide enhanced friction and a secure grip under wet conditions, including pool, beach, and marine environments, where prior art smooth-surfaced foam beverage holders provide inadequate grip and are prone to slippage.

As shown in FIG. 10, each exterior facing crest 128 is preferably located at the same angular position about axis 110 (shown in FIG. 8) as an interior facing valley 132. Similarly, each interior facing crest 126 is located at the same angular position as an exterior facing valley 130. This means that the locations at which the user's hand contacts the exterior of the beverage holder 100 through the exterior facing crests 128 are radially opposite the void spaces 136 of the interior bore 120, and the locations at which the beverage holder 100 contacts the can 202 through the discrete contact zones 134 are radially opposite the exterior facing valleys 130 on the exterior surface 104. This alternating, radially offset arrangement is a direct result of the corrugated wall structure and is integral to both the insulating and grip performance of beverage holders 100 according to the invention.

The exterior facing crests 128 are oriented in a spiral or helical pattern about the central axis 110, consistent with the helical orientation of the corrugated wall profile described above, providing the exterior spiral texture visible in FIGS. 1A through 5. In a preferred embodiment, one or more substantially planar or recessed badge areas 138 are formed on the exterior surface 104, each configured to receive a logo, brand identifier, or decorative graphic element.

When a beverage container 202 is inserted through the upper opening 118 into the interior bore 120 of the beverage holder 100, the exterior surface 200 of the beverage container 202 contacts the beverage holder 100 only at the discrete contact zones 134, which are the radially inward tips of the interior facing crests 126. The interior facing valleys 132 between successive interior facing crests 126 do not contact the exterior surface 200 of the beverage container 202. Accordingly, the total contact surface area between the beverage holder 100 and the exterior surface 200 of the beverage container 202 is substantially reduced as compared to prior art beverage holders having a smooth, flat interior bore surface.

This reduction in contact surface area provides three independent but synergistic functional benefits.

First, the void spaces 136 defined by the interior facing valleys 132 capture and retain a layer of air between the exterior surface 200 of the beverage container 202 and the interior surface 106 of the body 102. Air is a significantly poorer thermal conductor than EVA foam, neoprene, steel, or any other foam or metal material employed in prior art beverage holders. Accordingly, the air layer trapped within the void spaces 136 acts as an additional thermal insulating barrier between the beverage container 202 and the ambient environment, reducing the rate of heat transfer to the beverage contained therein and thereby maintaining the beverage at a desired cold temperature for a longer period of time. In preliminary testing, a sealed beverage container received within the beverage holder 100 exhibited a measurably reduced rate of temperature increase as compared to an uncovered beverage container over a 105-minute test period, both indoors and in direct sunlight. Formal empirical testing with production materials will be conducted to confirm and further quantify this result.

Second, the reduction in contact surface area between the discrete contact zones 134 and the exterior surface 200 of the beverage container 202 directly reduces the frictional force that must be overcome when inserting or removing a beverage container 202 from the interior bore 120. Prior art foam beverage holders having smooth interior bore surfaces present a comparatively large contact surface area against the exterior of a beverage container, resulting in high insertion and removal friction, particularly when the beverage container is cold and condensation has formed on its exterior surface. The discrete contact zones 134 of the present invention concentrate contact between the interior surface 106 and the beverage container 202 at isolated points defined by the radially inward tips of the interior facing crests 126, thereby substantially reducing the total friction force and permitting easier insertion and removal of the beverage container 202 without compromising the retention and insulating performance provided by the body 102.

Third, the corrugated wall structure provides simultaneous functional performance on both the interior and exterior faces of the foam wall 108 from a single integrated structural feature. The user's hand engages the exterior facing crests 128 for grip, while the beverage container 202 contacts the interior facing crests 126 for retention and reduced friction. Because these two sets of contact zones are radially offset from each other by the corrugated wall geometry, neither set of contact zones interferes with the other's function, and the performance of each is independent of the other.

In a preferred embodiment, the corrugated wall profile follows a continuous helical or spiral path about the central axis 110, such that the series of alternating interior facing crests 126 and exterior facing crests 128 traces a helical path from a point proximate the upper end 112 to a point proximate the lower end 114 of the body 102. In a preferred embodiment, the helix angle of the corrugated wall profile, as measured from the central longitudinal axis 110, is between approximately 10 degrees and 60 degrees, and more preferably between approximately 20 degrees and 45 degrees, though the invention is not limited to any particular helix angle.

The amplitude of the corrugated wall profile (i.e., the radial distance between the tip of an interior facing crest 126 and the base of the adjacent interior facing valley 132) and the pitch of the corrugations (i.e., the circumferential spacing between successive interior facing crests 126) may be varied across embodiments to achieve a desired ratio of contact zone area to void space area. In a preferred embodiment, the interior facing crests 126 collectively define a total contact surface area that is less than approximately fifty percent of the total interior bore surface area, and more preferably less than approximately thirty percent of the total interior bore surface area, such that the void spaces 136 constitute the majority of the interface between the beverage holder 100 and a beverage container 202 received therein.

In alternative embodiments, the interior surface of the body may define a plurality of discrete, bounded void spaces arranged in a non-contiguous pattern, such as a square grid, a honeycomb grid, a waffle pattern, or an array of individual dimples or recesses. In such embodiments, each void space is an individual closed or semi-closed cell bounded on its lateral sides by the contact zone surfaces that surround it, rather than being connected to adjacent void spaces by a continuous channel. Such discrete void configurations retain air within each bounded cell during use, providing thermal insulation in the same manner as described above. In embodiments employing discrete, bounded void spaces, one or more drainage channels or interior apertures may optionally be formed on the interior surface of the body or through the foam wall to permit drainage of water accumulated within individual void spaces during use in aquatic environments, thereby maintaining the thermal insulating and low-friction performance of the beverage holder.

While the preferred embodiment employs a sinusoidal or wave-like corrugated wall profile as shown in FIG. 10, other corrugated cross-sectional profiles, including but not limited to trapezoidal, triangular, square-wave, or asymmetric wave profiles, that produce alternating interior facing crests and exterior facing crests in a radially offset arrangement are within the scope of the present invention, provided that such profiles define discrete interior facing contact zones and intervening void spaces as described herein.

As noted above, the body 102 is formed from EVA foam in a preferred embodiment. EVA foam is characterized by a closed-cell or semi-closed-cell structure, relatively low density, high compressibility, and excellent resistance to water absorption. These properties render EVA foam particularly well suited for use in aquatic recreational environments where prior art neoprene koozies lose grip and insulating performance upon prolonged water exposure. The low density of EVA foam imparts sufficient buoyancy to the beverage holder 100 such that a sealed, filled beverage container 202 received within the beverage holder has a combined density permitting at least partial flotation in fresh water or salt water, reducing the risk of loss of the beverage container in aquatic environments.

In an alternative embodiment, a portion of the EVA foam material of the body 102 may be replaced with or supplemented by a bio-based or algae-derived foam material incorporating an algae-derived additive produced by harvesting excess algae biomass from waterways, thereby supporting aquatic ecosystem management, while retaining the functional properties described herein. This algae-based material alternative constitutes a preferred embodiment of the present invention for applications in which environmental sustainability is a design priority.

In a preferred embodiment, the body 102, including the corrugated wall profile, the exterior facing crests 128, the interior facing crests 126, and the associated surface features, is formed in a single blown foam molding operation in which the EVA foam material is expanded into a mold defining both the exterior and interior surface geometries of the body 102. The corrugated wall profile is produced by the geometry of the mold cavity, which incorporates alternating radial projections and recesses on both the inner and outer mold surfaces in the radially offset arrangement described herein. The integral formation of the corrugated wall profile during the molding process eliminates secondary manufacturing steps and ensures dimensional consistency and structural integrity of the corrugated features. The molding process further permits decorative surface variations, including speckled or mottled surface patterns on the exterior surface 104, to be incorporated into the body 102 during formation.

In a further preferred embodiment, the body 102 undergoes a post-molding pre-shrinking treatment after molding, in which the body 102 is subjected to a controlled application of heat, preferably via a conveyor heat application process, to induce a controlled and uniform reduction in the outer dimensions of the body 102. This pre-shrinking treatment ensures that the interior bore 120 achieves a precise and consistent dimensional relationship with standard beverage container formats, providing the desired snug, controlled fit between the interior bore 120 and a received beverage container 202 as described above. In some cases, an electrochemical application of a pattern on the inner diameter mold may also provide a desired fit and friction characteristic.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A beverage holder comprising:
a body formed from a resilient foam material, the body defining a central longitudinal axis, an upper opening, and an interior bore configured to receive a beverage container;
wherein an interior surface of the body bounding the interior bore includes a plurality of surface features defining discrete contact zones and intervening void spaces;
the discrete contact zones being configured to contact an exterior surface of a beverage container received within the interior bore; and
the void spaces being configured to retain air between the interior surface and the exterior surface of the received beverage container;
whereby the discrete contact zones define a total contact surface area that is less than a total surface area of the interior bore.

2. The beverage holder of claim 1, wherein the surface features follow a geometric pattern selected from the group consisting of a helical pattern, a spiral pattern, a circumferential pattern, a hexagonal pattern, a square pattern, a rectangular pattern, a waffle pattern, and a dimple pattern.

3. The beverage holder of claim 1, wherein the body has a corrugated wall profile comprising: interior facing crests projecting radially inward toward the central longitudinal axis; exterior facing crests projecting radially outward away from the central longitudinal axis; interior facing valleys defined between successive interior facing crests; and exterior facing valleys defined between successive exterior facing crests; wherein each interior facing crest is positioned at the same angular location as a corresponding exterior facing valley, and each exterior facing crest is positioned at the same angular location as a corresponding interior facing valley.

4. The beverage holder of claim 3, wherein the corrugated wall profile follows a helical path along the central longitudinal axis from a lower end of the body toward the upper opening.

5. The beverage holder of claim 4, wherein the helical path defines a helix angle measured relative to a plane perpendicular to the central longitudinal axis, the helix angle being in the range of approximately 10 degrees to approximately 60 degrees.

6. The beverage holder of claim 3, wherein the exterior facing crests of the corrugated wall profile define a textured exterior gripping surface configured for engagement by a user's hand, such that the corrugated wall profile simultaneously defines the discrete contact zones and void spaces on the interior surface and the textured gripping surface on the exterior surface.

7. The beverage holder of claim 3, wherein the corrugated wall profile has a sinusoidal cross-sectional profile.

8. The beverage holder of claim 1, wherein the foam material is ethylene-vinyl acetate (EVA) foam.

9. The beverage holder of claim 8, wherein the body has a density and wall thickness sufficient to provide positive buoyancy for a sealed beverage container received within the interior bore when the beverage holder is placed in water.

10. The beverage holder of claim 1, further comprising one or more drainage apertures formed at or near a lower end of the body and configured to permit drainage of water from the interior bore.

11. The beverage holder of claim 1, wherein the body is formed by a blown foam molding process.

12. A method of manufacturing a beverage holder, the method comprising:
providing a foam material;
introducing the foam material into a mold cavity having a corrugated interior profile; and
expanding the foam material within the mold cavity to form a body having an interior bore configured to receive a beverage container, the expanding step simultaneously forming a plurality of surface features on an interior surface of the body by conforming the foam material to the corrugated interior profile of the mold cavity, the surface features defining discrete contact zones and intervening void spaces configured to retain air between the interior surface and an exterior surface of a beverage container received within the interior bore.

13. The method of claim 12, wherein the mold cavity is configured such that the interior bore of the body as formed has a diameter that is smaller than an exterior diameter of the beverage container to be received, and the method further comprises:
removing the body from the mold cavity after the foam material has set; and
inserting a beverage container into the interior bore by elastically deforming the body, thereby establishing a frictionally retained fit between the interior bore and the beverage container.

14. The method of claim 12, wherein the mold cavity has a helical corrugated interior profile, such that the surface features formed on the interior surface of the body follow a helical path along a central longitudinal axis of the body from a lower end of the body toward an upper opening.

15. The method of claim 12, wherein the foam material is ethylene-vinyl acetate (EVA) foam.

16. The method of claim 12, wherein introducing the foam material into the mold cavity and expanding the foam material simultaneously forms a textured exterior gripping surface on an exterior surface of the body, the textured exterior gripping surface comprising exterior facing crests defined by the corrugated interior profile of the mold cavity.

17. The method of claim 12, further comprising forming one or more drainage apertures at or near a lower end of the body during the expanding step.

18. A beverage holder comprising:
a body formed from ethylene-vinyl acetate (EVA) foam by a blown foam molding process, the body defining a central longitudinal axis, an upper opening, a lower end, and an interior bore extending from the upper opening toward the lower end;
the body having a corrugated wall profile comprising interior facing crests projecting radially inward, exterior facing crests projecting radially outward, interior facing valleys defined between successive interior facing crests, and exterior facing valleys defined between successive exterior facing crests, wherein the interior facing crests are angularly offset from the exterior facing crests such that each interior facing crest is positioned at the same angular location as a corresponding exterior facing valley; the interior facing crests defining discrete contact zones configured to contact an exterior surface of a beverage container received within the interior bore;
the interior facing valleys defining void spaces configured to retain air between the interior surface of the body and the exterior surface of the received beverage container;
the exterior facing crests defining a textured exterior gripping surface; and
the body having a density and wall thickness sufficient to provide positive buoyancy for a sealed beverage container received within the interior bore when the beverage holder is placed in water.

19. The beverage holder of claim 18, wherein the corrugated wall profile follows a helical path along the central longitudinal axis, the helical path defining a helix angle in the range of approximately 10 degrees to approximately 60 degrees measured relative to a plane perpendicular to the central longitudinal axis.

20. The beverage holder of claim 18, further comprising one or more drainage apertures formed at or near the lower end and configured to permit drainage of water from the interior bore.
